(19) United States
(12) Patent Application Publication
(10) Pub. No.: US 2026/0138580 A1
(43) Pub. Date: May 21, 2026

(54) AUTO GAIN FOR ELECTRIC BRAKE ACTUATOR CONTROLLER

(71) Applicant: Goodrich Corporation, Charlotte, NC (US)

(72) Inventor: James Michael Martin, JR., Dayton, OH (US)

(73) Assignee: Goodrich Corporation, Charlotte, NC (US)

(21) Appl. No.: 18/953,313

(22) Filed: Nov. 20, 2024

(51) Int. Cl. B60T 13/74; B60T 8/17; B60T 13/66

(52) U.S. Cl. CPC B60T 13/741; B60T 8/1703; B60T 13/662

(57) ABSTRACT

A brake system is disclosed herein. The brake system includes a pressure plate, an end plate, a plurality of rotating discs, and stationary discs positioned between the pressure plate and the end plate, an electromechanical brake actuator controller, and an electromechanical brake actuator including a ball screw configured to extend to exert force on the pressure plate, the rotating discs, the stationary discs, and the end plate to generate a braking torque, the electromechanical brake actuator operatively coupled to the electromechanical brake actuator controller. Responsive to receiving a commanded level of braking force from the brake control unit, the electromechanical brake actuator controller is configured to command the electromechanical brake actuator to apply a correct level of braking force, the correct level of braking force being a measured level of braking force corrected by an auto gain correction factor.

### FIELD

The present disclosure relates to aircraft braking systems, and more specifically, to an auto gain for an electromechanical brake actuator controller.

### BACKGROUND

Typically, an aircraft may include a plurality of electromechanical brake (E-brake) assemblies that are configured to apply force to a brake stack on an aircraft wheel. Typically, a load cell signal is utilized for brake force measurement and feedback for accurate force control. A typical E-brake contains four electromechanical brake actuators (EBAs) located approximately 90 degrees apart from each other around the brake and there is one load cell sensor per EBA.

### SUMMARY

A brake system is disclosed herein. The brake system includes a pressure plate, an end plate, a plurality of rotating discs and stationary discs positioned between the pressure plate and the end plate, a brake control unit, an electromechanical brake actuator controller, and an electromechanical brake actuator. The electromechanical brake actuator includes a ball screw configured to extend to exert a force on the pressure plate, the rotating discs, the stationary discs, and the end plate to generate a braking torque. The electromechanical brake actuator is operatively coupled to the electromechanical brake actuator controller. Responsive to receiving a commanded level of braking force from the brake control unit, the electromechanical brake actuator controller is configured to command the electromechanical brake actuator to apply a correct level of braking force. The correct level of braking force being a measured level of braking force corrected by an auto gain correction factor.

In various embodiments, the auto gain correction factor is determined by dividing an actual displacement of a brake stack under 100% braking force by an expected displacement of the brake stack at 100% braking force for a given wear state of the brake stack.

In various embodiments, the expected displacement of the brake stack at the 100% braking force is determined during brake system development and qualification and is stored as data in the electromechanical brake actuator controller.

In various embodiments, the actual displacement is an indication of a specific force applied to a brake stack that is at a particular wear state. In various embodiments, the expected displacement of the brake stack is based on the same particular wear state of the brake stack.

In various embodiments, the brake system includes a load cell. In various embodiments, determining the correct level of braking force includes the electromechanical brake actuator controller being configured to: responsive to receiving the commanded level of braking force from the brake control unit, identify an electromechanical brake actuator power required to achieve the commanded level of braking force; send the electromechanical brake actuator power to the electromechanical brake actuator; receive, from the load cell, an applied braking force signal indicating the measured level of braking force corresponding to the electromechanical brake actuator power; correct the measured level of braking force by the auto gain correction factor thereby forming a corrected braking force; determine whether the corrected braking force has achieved the commanded level of braking force; and, responsive to the corrected braking force failing to achieve the commanded level of braking force, send an adjusted electromechanical brake actuator power to the electromechanical brake actuator.

In various embodiments, determining the correct level of braking force includes the electromechanical brake actuator controller being configured to, responsive to the corrected braking force achieving the commanded level of braking force, maintain the electromechanical brake actuator power to the electromechanical brake actuator.

In various embodiments, the electromechanical brake actuator is a plurality of electromechanical brake actuators. In various embodiments, the electromechanical brake actuator controller is configured to command each electromechanical brake actuator of the plurality of electromechanical brake actuators individually to apply a respective correct level of braking force. The respective correct level of braking force being a respective measured level of braking force corrected by a respective auto gain correction factor associated with the respective electromechanical brake actuator.

Also disclosed herein is an aircraft. The aircraft includes a wheel and a brake system coupled to the wheel. The brake system includes a pressure plate, an end plate, a plurality of rotating discs and stationary discs positioned between the pressure plate and the end plate, a brake control unit, an electromechanical brake actuator controller, and an electromechanical brake actuator. The electromechanical brake actuator includes a ball screw configured to extend to exert a braking force on the pressure plate, the rotating discs, the stationary discs, and the end plate to generate a braking torque. The electromechanical brake actuator is operatively coupled to the electromechanical brake actuator controller. Responsive to receiving a commanded level of braking force from the brake control unit, the electromechanical brake actuator controller is configured to command the electromechanical brake actuator to apply a correct level of braking force, the correct level of braking force being a measured level of braking force corrected by an auto gain correction factor.

In various embodiments, the auto gain correction factor is determined by dividing an actual displacement of a brake stack under 100% braking force by an expected displacement of the brake stack at 100% braking force based on a given wear state of the brake stack.

In various embodiments, the expected displacement of the brake stack at the 100% braking force is determined during brake system development and qualification and is stored as data in the electromechanical brake actuator controller.

In various embodiments, the actual displacement is an indication of a specific force applied to a brake stack that is at a particular wear state of the brake stack. In various embodiments, the expected displacement of the brake stack is based on the same particular wear state of the brake stack.

In various embodiments, the brake system includes a load cell. In various embodiments, determining the correct level of braking force includes the electromechanical brake actuator controller being configured to: responsive to receiving the commanded level of braking force from the brake control unit, identify an electromechanical brake actuator power required to achieve the commanded level of braking force; send the electromechanical brake actuator power to the electromechanical brake actuator; receive, from the load cell, an applied braking force signal indicating the measured level of braking force corresponding to the electromechanical brake actuator power; correct the measured level of braking force by the auto gain correction factor thereby forming a corrected braking force; determine whether the corrected braking force has achieved the commanded level of braking force; and, responsive to the corrected braking force failing to achieve the commanded level of braking force, send an adjusted electromechanical brake actuator power to the electromechanical brake actuator.

In various embodiments, determining the correct level of braking force includes the electromechanical brake actuator controller being configured to, responsive to the corrected braking force achieving the commanded level of braking force, maintain the electromechanical brake actuator power to the electromechanical brake actuator.

In various embodiments, the electromechanical brake actuator is a plurality of electromechanical brake actuators. In various embodiments, the electromechanical brake actuator controller is configured to command each electromechanical brake actuator of the plurality of electromechanical brake actuators individually to apply a respective correct level of braking force, the respective correct level of braking force being a respective measured level of braking force corrected by a respective auto gain correction factor associated with the respective electromechanical brake actuator.

Also disclosed herein is a method of controlling an electromechanical brake actuator of a brake system. The method incudes receiving, by an electromechanical brake actuator controller, a commanded level of braking force from a brake control unit, where the commanded level of braking is to extend a ball screw within the electromechanical brake actuator toward a pressure plate and exert a force on the pressure plate, rotating discs, stationary discs, and an end plate to generate a braking torque; and commanding, by the electromechanical brake actuator controller, the electromechanical brake actuator to apply a correct level of braking force, the correct level of braking force being a measured level of braking force corrected by an auto gain correction factor.

In various embodiments, the auto gain correction factor is determined by dividing an actual displacement of a brake stack under 100% braking force by an expected displacement of the brake stack at 100% braking force based for a given wear state of the brake stack.

In various embodiments, the expected displacement of the brake stack at 100% braking force is determined during brake system development and qualification and is stored as data in the electromechanical brake actuator controller.

In various embodiments, the actual displacement is an indication of a specific force applied to a brake stack that is at a particular wear state of the brake stack. In various embodiments, the expected displacement of the brake stack is based on the same particular wear state of the brake stack.

In various embodiments, the method further includes determining, by the electromechanical brake actuator controller, the correct level of braking force by: responsive to receiving the commanded level of braking force from the brake control unit, identify, by the electromechanical brake actuator controller, an electromechanical brake actuator power required to achieve the commanded level of braking force; sending, by the electromechanical brake actuator controller, the electromechanical brake actuator power to the electromechanical brake actuator; receiving, by the electromechanical brake actuator controller from a load cell, an applied force signal indicating the measured level of braking force corresponding to the electromechanical brake actuator power; correcting, by the electromechanical brake actuator controller, the measured level of braking force by the auto gain correction factor thereby forming a corrected braking force; determining, by the electromechanical brake actuator controller, whether the corrected braking force has achieved the commanded level of braking force; and, responsive to the corrected braking force failing to achieve the commanded level of braking force, sending, by the electromechanical brake actuator controller, an adjusted electromechanical brake actuator power to the electromechanical brake actuator.

In various embodiments, the method further includes, responsive to the corrected braking force achieving the commanded level of braking force, maintaining, by the electromechanical brake actuator controller, the electromechanical brake actuator power to the electromechanical brake actuator.

The forgoing features and elements may be combined in various combinations without exclusivity, unless expressly indicated herein otherwise. These features and elements as well as the operation of the disclosed embodiments will become more apparent in light of the following description and accompanying drawings.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the detailed description and claims when considered in connection with the drawing figures, wherein like numerals denote like elements.

FIG. 1A illustrates an aircraft having multiple landing gear and brakes, in accordance with various embodiments.

FIG. 1B illustrates an aircraft electric brake in accordance with various embodiments.

FIG. 1C illustrates a cross-sectional view of an aircraft electric brake arrangement along line A-A of FIG. 1B, in accordance with various embodiments.

FIG. 2 illustrates a functional diagram of a typical electric braking system, in accordance with various embodiments.

FIGS. 3A, 3B, and 3C illustrate a method for determining and applying an Auto Gain Correction Factor (AGCF) to control a typical electromechanical brake (E-brake) system, in accordance with various embodiments.

FIG. 4 illustrates a graph of load cell accuracy (LCA) error with and without the auto gain correct faction (AGCF) applied for an electromechanical brake actuator (EBA), in accordance with various embodiments.

### DETAILED DESCRIPTION

The detailed description of exemplary embodiments herein makes reference to the accompanying drawings, which show exemplary embodiments by way of illustration. While these exemplary embodiments are described in sufficient detail to enable those skilled in the art to practice the disclosure, it should be understood that other embodiments may be realized and that logical changes and adaptations in design and construction may be made in accordance with this disclosure and the teachings herein. Thus, the detailed description herein is presented for purposes of illustration only and not of limitation. The scope of the disclosure is defined by the appended claims. For example, the steps recited in any of the method or process descriptions may be executed in any order and are not necessarily limited to the order presented. Furthermore, any reference to singular includes plural embodiments, and any reference to more than one component or step may include a singular embodiment or step.

As used herein, “electronic communication” means communication of electronic signals with physical coupling (e.g., “electrical communication” or “electrically coupled”) or without physical coupling and via an electromagnetic field (e.g., “inductive communication” or “inductively coupled” or “inductive coupling”).

While described in the context of aircraft applications, and more specifically, in the context of brake control, the various embodiments of the present disclosure may be applied to any suitable application.

As stated previously, an aircraft utilizing an electromechanical brake (E-brake) system may comprise a plurality of electromechanical brake (E-brake) assemblies that are configured to apply force to a brake stack on an aircraft wheel. A typical E-brake contains four electromechanical brake actuators (EBAs) located approximately 90 degrees apart from each other around the brake and there is one load cell sensor per EBA. However, typical E-brake assemblies may fail to provide for auto tuning the gain (slope) of the load cell within an EBA. Thus, load cells that determine a brake force measurement of each EBA and provide feedback for accurate force control via a load cell signal may, over time in service, drift out of calibration such that the EBA may no longer achieve accurate force at all braking levels. This drift especially impacts load cell accuracy at maximum force levels. Currently, retuning of a load cell is performed during maintenance overhaul and repair (MRO) which may be costly and requires the aircraft to be out of service.

Disclosed herein is an electromechanical brake (E-brake) system that includes an electromechanical brake actuator controller (EBAC) configured to determine an auto gain correction factor and auto correct the load cell gain thereby improving an accuracy of the force applied by the associated EBA(s). In various embodiments, the EBAC is configured to utilize either an electronic wear pin mechanism of the EBA or another electronic wear pin measurement mechanism to identify the wear state of a heat sink assembly, i.e. a brake stack. In various embodiments, the EBAC is configured to identify physical properties of the brake stack (carbon, steel, etc.) at an applied force compression of 100%, i.e. an expected movement. In various embodiments, the EBAC is configured to identify an actual movement of the EBA during application of force from zero torque point (ZTP=Zero Torque Point, refers to when the EBA is touching the brake stack but not yet applying force), i.e., zero force to a 100% commanded force. In various embodiments, by comparing the actual movement of the EBA to the expected movement of the EBA, the EBAC is configured to determine an auto gain correction factor (AGCF) that may be utilized to auto correct the load cell gain and thereby improve an accuracy of the force applied by the associated EBA(s).

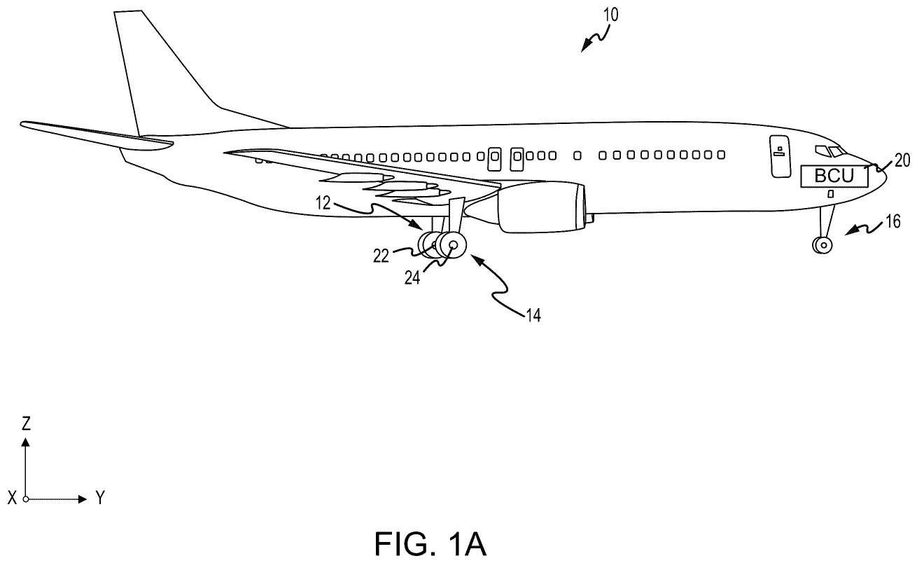

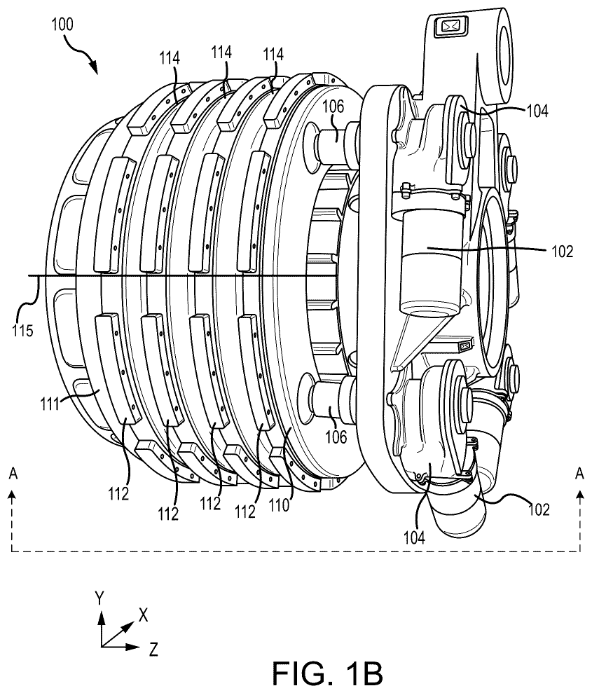

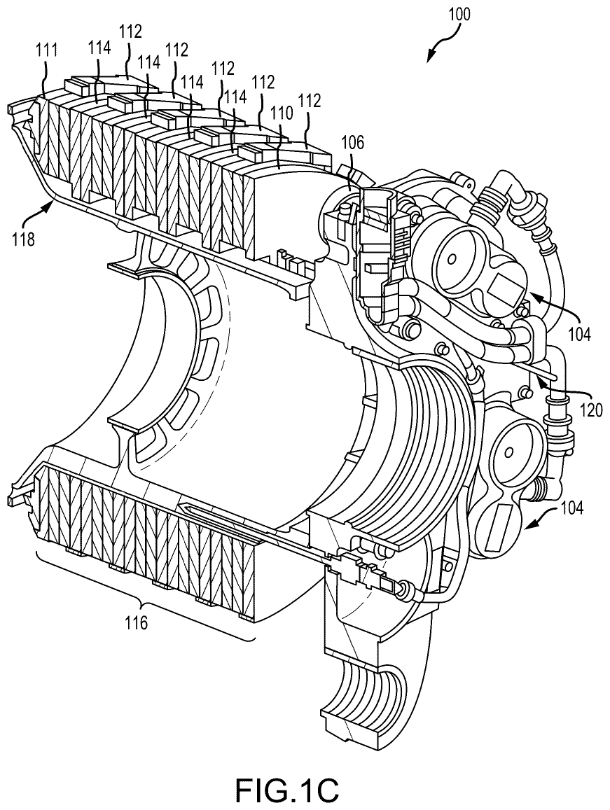

Referring to FIG. 1A, in accordance with various embodiments, an aircraft 10 is illustrated. The aircraft 10 includes a landing gear, which may include a left main landing gear 12, a right main landing gear 14 and a nose landing gear 16. The landing gear support the aircraft 10 when it is not flying, allowing the aircraft 10 to taxi, take off, and land without damage. While the disclosure refers to the three landing gear configurations just referred, the disclosure nevertheless contemplates any number of landing gear configurations.

Aircraft 10 may further include a brake control unit (BCU) 20 for controlling a left main brake mechanism 22 of left main landing gear 12 and a right main brake mechanism 24 of right main landing gear 14. BCU 20 controls the application of brake mechanisms 22, 24 in response to input from aircraft 10 or an authorized user. BCU 20 further controls a parking brake functionality of brake mechanisms 22, 24 to secure aircraft 10 in place. A plurality of wires that independently control the braking and parking brake functionalities run through aircraft 10 from BCU 20 to left main brake mechanism 22 and right main brake mechanism 24.

Referring to FIG. 1B, in accordance with various embodiments, an aircraft electric brake arrangement 100 is illustrated. Aircraft electric brake arrangement 100 may include a plurality of actuator motors 102, a plurality of electromechanical brake actuators (EBAs) 104, a plurality of ball screws 106, an end plate 111 and a pressure plate 110, and a plurality of rotating discs 112 and stators 114 positioned in an alternating fashion between end plate 111 and pressure plate 110. Rotating discs 112 may rotate about an axis 115 and the stators 114 may have no angular movement relative to axis 115. Wheels may be coupled to rotating discs 112 such that a linear speed of the aircraft is proportional to the angular speed of rotating discs 112. As force is applied to pressure plate 110 towards end plate 111 along the axis 115, rotating discs 112 and stators 114 are forced together in an axial direction. This causes the rotational speed of rotating discs 112 to become reduced (i.e., causes braking effect) due to friction between rotating discs 112, stators 114, end plate 111 and pressure plate 110. In response to sufficient force being exerted on rotating discs 112 via pressure plate 110, the rotating discs 112 will stop rotating.

In order to exert this force onto pressure plate 110, actuator motor 102 may cause EBA 104 to actuate. Although referred to herein as EBA 104, it is contemplated that, in various embodiments, EBA 104 may be an electrohydraulic actuator. In various embodiments, actuator motor 102 may be a brushless motor, such as a permanent magnet synchronous motor (PMSM), a permanent-magnet motor (PMM) or the like. In various embodiments, EBA 104 may be coupled to or otherwise operate a motor shaft and a pressure generating device, such as, for example, a ball screw, a ram, and/or the like. In response to actuation or a brake command, EBA 104 causes the motor shaft to rotate. Rotation of the motor shaft 204 may cause rotation of a ball screw 106, and rotational motion of the ball screw 106 may be transformed into linear motion of a ball screws 106. Linear translation of ball screws 106 towards pressure plate 110 applies force on pressure plate 110 towards end plate 111. EBA 104 is actuated in response to electrical current being applied to actuator motor 102. The amount of force applied by EBA 104 is related to the amount of electrical current applied to actuator motor 102.

Referring to FIG. 1C, in accordance with various embodiments, a cross-sectional view of an aircraft electric brake arrangement 100 along line A-A of FIG. 1B is illustrated. As with FIG. 1B, the aircraft electric brake arrangement 100 of FIG. 1C may include a plurality of rotating discs 112 and stators 114 positioned in an alternating fashion that form a heat sink assembly 116, i.e. a brake stack, formed around a torque plate assembly 118 between end plate 111 and pressure plate 110. As force is applied to pressure plate 110 towards end plate 111 along the axis 115, rotating discs 112 and stators 114 are forced together in an axial direction. This causes the rotational speed of rotating discs 112 to become reduced (i.e., causes braking effect) due to friction between rotating discs 112, stators 114, end plate 111 and pressure plate 110. In response to sufficient force being exerted on rotating discs 112 via pressure plate 110, the rotating discs 112 will stop rotating.

In order to exert this force onto pressure plate 110, an actuator motor, such as actuator motor 102 of FIG. 1B, may cause EBA 104 to actuate. Although referred to herein as EBA 104, it is contemplated that, in various embodiments, EBA 104 may be an electrohydraulic actuator. In various embodiments, actuator motor may be a brushless motor, such as a permanent magnet synchronous motor (PMSM), a permanent-magnet motor (PMM) or the like. In various embodiments, EBA 104 may be coupled to or otherwise operate a motor shaft and a pressure generating device, such as, for example, a ball screw, a ram, and/or the like. In response to actuation or a brake command, EBA 104 causes the motor shaft to rotate. Rotation of the motor shaft may cause rotation of a ball screw 106, and rotational motion of the ball screw 106 may be transformed into linear motion of a ball screws 106. Linear translation of ball screws 106 towards pressure plate 110 applies force on pressure plate 110 towards end plate 111. EBA 104 is actuated in response to electrical current being applied to the actuator motor. The amount of force applied by EBA 104 is related to the amount of electrical current applied to the actuator motor 102. Additionally, the aircraft electric brake arrangement 100 may include a wear pin 120 that indicates a wear state of the heat sink assembly 116. In various embodiments, the wear pin 120 may be an electronic wear pin that indicates an actual displacement of the heat sink assembly 116 or the wear pin 120 may be monitored by an electronic wear pin measurement mechanism to identify the actual displacement of a heat sink assembly 116.

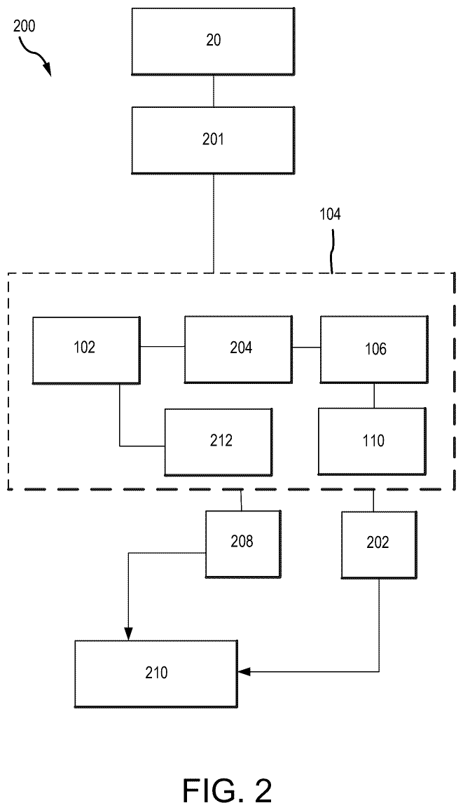

With further reference to FIG. 2, in various embodiments, a functional diagram of a typical electric braking system is illustrated. In various embodiments, an electromechanical brake actuator control system 200, or brake system, may include an electromechanical brake actuator controller (EBAC) 201 in communication with each EBA 104. In various embodiments, the electromechanical brake actuator control system 200 may include an electrical current sensor 212 to detect an amount of electrical current provided to actuator motor 102. Electrical current sensor 212 may be in communication with actuator motor 102 and/or with various other components of an EBA 104, an electromechanical brake actuator control system 200, and/or an aircraft 10. In various embodiments, electrical current sensor 212 may be disposed on or adjacent to actuator motor 102. However, in various embodiments, the electrical current sensor 212 may be disposed in any location suitable for detection of electrical current supplied to the actuator motor 102, such as, for example, in the EBAC 201.

Application of electrical current to actuator motor 102 causes rotation of motor shaft 204. In various embodiments, electromechanical brake actuator control system 200 may include a position sensor 208. Position sensor 208 may be configured so as to measure the rotational speed and position of motor shaft 204. In various embodiments, position sensor 208 may be disposed in or adjacent to EBA 104, or on or adjacent to actuator motor 102. However, position sensor 208 may be disposed in any location suitable for detection of the rotational speed and position of motor shaft 204. In various embodiments, position sensor 208 may include a resolver, tachometer, or Hall sensor, among others.

In various embodiments, electromechanical brake actuator control system 200 may include a load cell 202. Load cell 202 may be configured so as to measure the amount of force being applied between ball screws 106 and pressure plate 110. In various embodiments, load cell 202 may be disposed in or adjacent to EBA 104, or on or adjacent to ball screws 106. However, load cell 202 may be disposed in any location suitable for detection of the force being applied between ball screws 106 and pressure plate 110. A controller may receive the detected force and rotational speed, and calculate an adjusted force and an adjusted rotational speed based on those detected values. In various embodiments, electromechanical brake actuator control system 200 may include a fault tolerant module 210.

In various embodiments, a system for brake actuator operation with load cell fault tolerant technology includes four load cells 202, four electrical current sensors 212, four position sensors 208, and at least one controller. The system for multiple brake actuator operation via one load cell may include a fault tolerant module 210. In various embodiments, fault tolerant module 210 may be a controller and/or processor. In various embodiments, fault tolerant module 210 may be implemented in a single controller and/or processor. In various embodiments, fault tolerant module 210 may be implemented in multiple controllers and/or processors. In various embodiments, fault tolerant module 210 may be implemented in an electromechanical actuator controller and/or a brake control unit.

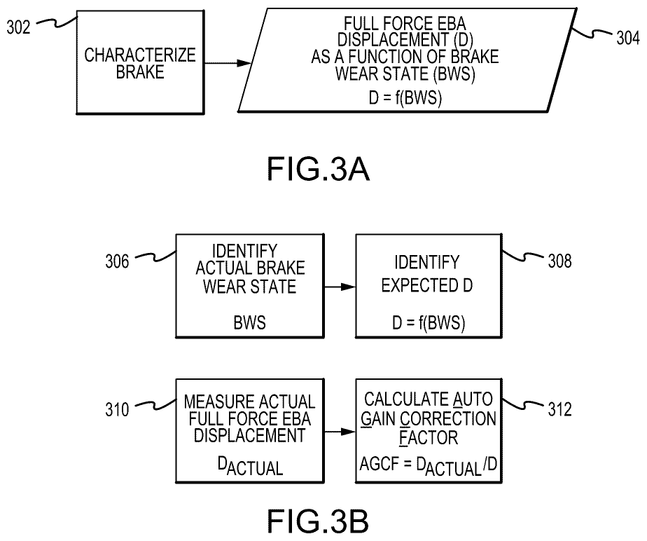

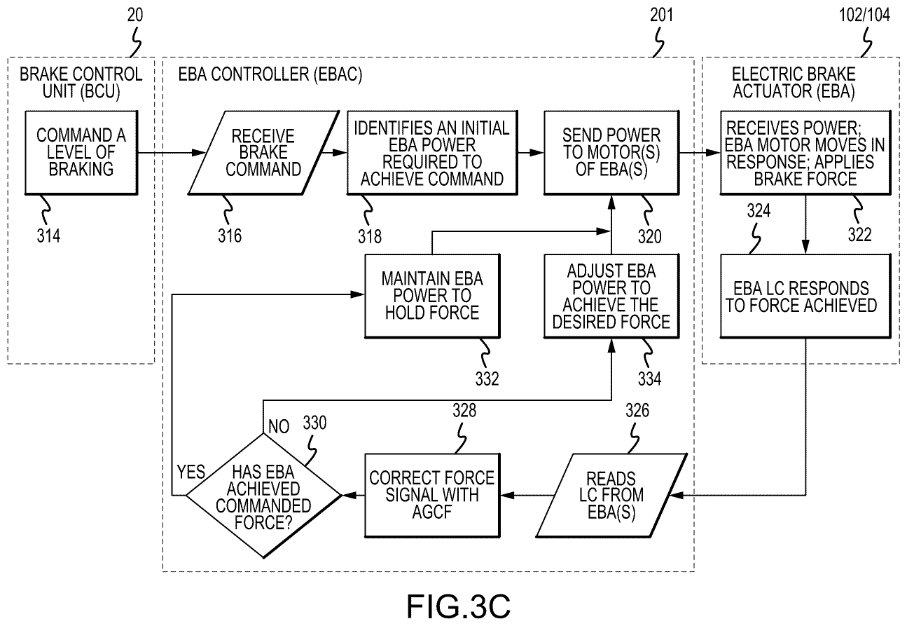

Referring now to FIGS. 3A, 3B, and 3C, in accordance with various embodiments, a method for determining and applying an Auto Gain Correction Factor (AGCG) to control a typical electromechanical brake (E-brake) system is illustrated. In various embodiments, as is illustrated in FIG. 3A, during brake system development and qualification, at block 302, the electronic brake (e-brake) system is characterized. In various embodiments, at block 304, the characterization includes the EBAC applying by each of the electromechanical brake actuators (EBA) 100% force to the heat sink assembly, such as heat sink assembly 116 of FIG. 1, and determining a displacement (D), i.e. expected displacement, as a function of the brake wear state (BWS) for each EBA. In that regard, in various embodiments, during brake system development and qualification, at various heat sink assembly wear states, i.e. 100%, 90%, 80%, 70%, 60%, 50%, 40%, 30%, 20%, and 10%, the displacement (D) of the each EBA is determined, and the expected displacement is stored in the EBAC for later uses, as described hereafter. In various embodiment, the displacement (D) may further be characterized per position on the aircraft brake arrangement. In that regard, in various embodiments, each aircraft brake arrangement may include four, eight, or more EBAs and the characterization may indicate a position of the EBA on the aircraft brake arrangement.

In various embodiments, as is illustrated in FIG. 3B, during in-service of the aircraft, at some regular interval during the in-service of the aircraft, at block 306, the EBAC is configured to identify the actual BWS of the brake stack of the aircraft. BWS may be determined using an electronic wear pin, a software-based wear pin measurement (e.g., based on EBA retract motion from ZTP to full retraction), or any other applicable method of determining the BWS. In various embodiments, the regular interval may be associated with a startup of the EBAC via a built-in test. In that regards, the regular interval may be every 10 power on events, every 15 power on events, or every 20 power on events, among others. In various embodiments, at block 308, based on the actual BWS and using the characterized displacement determined during brake system development and qualification at block 304, at block 308, the EBAC is configured to identify the expected displacement (D).

In various embodiments, at block 310 and at the regular interval, the EBAC is configured to send commands to have each EBA apply 100% force to the heat sink assembly and determine an actual displacement (Dactual) of each EBA using each EBA's internal motor commutation logic. As the EBAC applies ZTP to 100% force, the EBAC monitors the motion of each EBA motor(s) and determines how far the EBA ball screw has extended by during compression of the brake stack (Dactual). There are various methods, but generally, for each EBA, the number of EBA motor rotations may be monitored, and related to the ball screw motion based on the geometry and specifics of the EBA design (ball screw thread pitch, gear train ratio, etc.). In various embodiments, at block 312, the EBAC is configured to determine an auto gain correct faction (AGCF) by dividing the actual displacement (Dactual) by the expected displacement (D).

In various embodiments, as is illustrated in FIG. 3C, during any aircraft braking application, at block 314, a brake control unit (BCU), such as BCU 20 of FIG. 1A, issues a level of braking command. In various embodiments, at block 316, the EBAC receives the level of braking command from the BCU and, at block 318, for each EBA, the EBAC is configured to identify an initial EBA power required to achieve the level of braking. In various embodiments, based on the initial EBA power required to achieve the level of braking, at block 320, the EBAC is configured to send the identified EBA power to the respective motors of the EBAs, such as actuator motors 102 of EBA 104 of FIG. 1B. In various embodiments, at block 322, each motor is configured to receive the power from the EBAC and rotate the EBA to apply the requested braking force. In various embodiments, in response to the EBA applying the requested braking force, at block 324, the load cell, such as load cell 202 of FIG. 2, provides a force signal to the EBAC of the force achieved by the EBA.

In various embodiments, at block 326, the EBAC is configured to read the force signal from the load cell of EBA and, at block 328, corrects the force signal with the auto gain correct faction (AGCF) determined at block 312. In various embodiments, at block 330, the EBAC is configured to determine, based on the corrected force signal from the load cell, whether the EBA has achieved the command force. In various embodiments, responsive to the EBA has achieving the command force, at block 332, the EBAC is configured to maintain the EBA power to hold the applied force. In various embodiments, responsive to the EBA has failing to achieve the command force, at block 334, the EBAC is configured to adjust the EBA power to achieve the desired force.

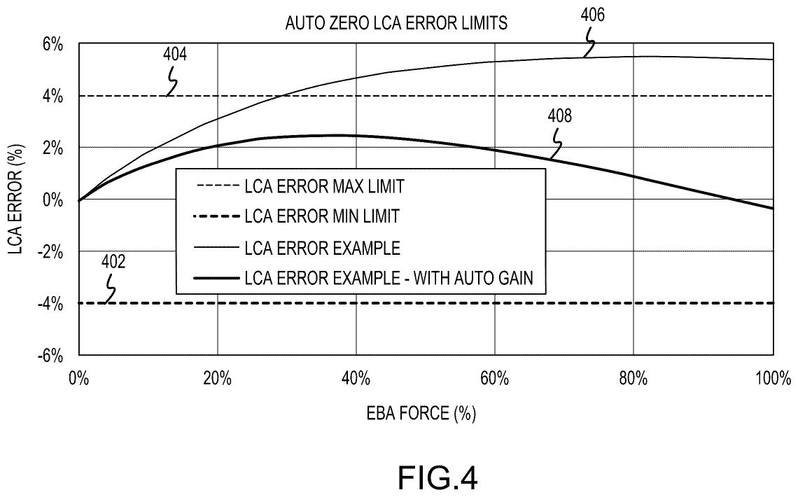

Referring now to FIG. 4, in accordance with various embodiments, a graph of load cell accuracy (LCA) error with and without the auto gain correct faction (AGCF) applied for an electromechanical brake actuator (EBA) is illustrated. Although not required, for this example, the graph has been “auto-zeroed,” meaning the LCA error at zero force is zero; as this is a typical feature of modern electric brake systems that utilize load cells. LCA Error is defined as: LCA Error %=(Measured Load Cell Force - Reference External Force)/Reference External Force. In various embodiments, the figure illustrates LCA error percentage versus EBA force percentage. In various embodiments, line 402 illustrates a LCA error minimum (min) limit and line 404 illustrates a LCA error maximum (max) limit. The value shown is for illustrative purposes only, the exact value of the min and max allowable error would vary based on the aircraft and brake system requirements. In various embodiments, over time in service, the LC accuracy may drift out of calibration such that the EBA may no longer achieve accurate force at all braking levels as illustrated by line 406 wherein the LCA error has exceeded the LCA error maximum (max) limit illustrated by line 404. In various embodiments, by utilized the embodiments described previously, utilizing the determined auto gain correction factor, the LCA gain may be auto corrected resulting in improved accuracy of the force applied by the EBA as illustrated by line 408. Accordingly, by adding auto gain, the accuracy of the forces applied by each EBA is improved across the full range of EBA force, especially at maximum force when it is important to generate the correct 100% force to meet brake force level requirements for rejected take off (RTO) and other safety critical scenarios.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

Systems, methods and apparatus are provided herein. In the detailed description herein, references to “various embodiments,” “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f), unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A brake system comprising:
a pressure plate;
an end plate;
a plurality of rotating discs and a plurality of stationary discs positioned between the pressure plate and the end plate;
a brake control unit;
an electromechanical brake actuator controller; and
an electromechanical brake actuator comprising a ball screw configured to extend to exert a force on the pressure plate, the plurality of rotating discs, the plurality of stationary discs, and the end plate to generate a braking torque, the electromechanical brake actuator operatively coupled to the electromechanical brake actuator controller,
wherein, responsive to receiving a commanded level of braking force from the brake control unit, the electromechanical brake actuator controller is configured to command the electromechanical brake actuator to apply a correct level of braking force, the correct level of braking force being a measured level of braking force corrected by an auto gain correction factor.

2. The brake system of claim 1, wherein the auto gain correction factor is determined by dividing an actual displacement of a brake stack under 100% braking force by an expected displacement of the brake stack at 100% braking force for a given wear state of the brake stack.

3. The brake system of claim 2, wherein the expected displacement of the brake stack at the 100% braking force is determined during brake system development and qualification and is stored as data in the electromechanical brake actuator controller.

4. The brake system of claim 2, wherein the actual displacement is an indication of a specific force applied to the brake stack that is at a particular wear state and wherein the expected displacement of the brake stack is based on the same particular wear state of the brake stack.

5. The brake system of claim 1, wherein the brake system further comprises:
a load cell,
wherein determining the correct level of braking force comprises the electromechanical brake actuator controller being configured to:
responsive to receiving the commanded level of braking force from the brake control unit, identify an electromechanical brake actuator power required to achieve the commanded level of braking force;
send the electromechanical brake actuator power to the electromechanical brake actuator;
receive, from the load cell, an applied braking force signal indicating the measured level of braking force corresponding to the electromechanical brake actuator power;
correct the measured level of braking force by the auto gain correction factor thereby forming a corrected braking force;
determine whether the corrected braking force has achieved the commanded level of braking force; and
responsive to the corrected braking force failing to achieve the commanded level of braking force, send an adjusted electromechanical brake actuator power to the electromechanical brake actuator.

6. The brake system of claim 5, wherein determining the correct level of braking force comprises the electromechanical brake actuator controller being configured to:
responsive to the corrected braking force achieving the commanded level of braking force, maintain the electromechanical brake actuator power to the electromechanical brake actuator.

7. The brake system of claim 1, wherein the electromechanical brake actuator is a plurality of electromechanical brake actuators, wherein the electromechanical brake actuator controller is configured to command each electromechanical brake actuator of the plurality of electromechanical brake actuators individually to apply a respective correct level of braking force, the respective correct level of braking force being a respective measured level of braking force corrected by a respective auto gain correction factor associated with the respective electromechanical brake actuator.

8. An aircraft, comprising:
a wheel; and
a brake system coupled to the wheel, wherein the brake system comprises:
a pressure plate;
an end plate;
a plurality of rotating discs and a plurality of stationary discs positioned between the pressure plate and the end plate;
a brake control unit;
an electromechanical brake actuator controller; and
an electromechanical brake actuator comprising a ball screw configured to extend to exert a force on the pressure plate, the plurality of rotating discs, the plurality of stationary discs, and the end plate to generate a braking torque, the electromechanical brake actuator operatively coupled to the electromechanical brake actuator controller,
wherein, responsive to receiving a commanded level of braking force from the brake control unit, the electromechanical brake actuator controller is configured to command the electromechanical brake actuator to apply a correct level of braking force, the correct level of braking force being a measured level of braking force corrected by an auto gain correction factor.

9. The aircraft of claim 8, wherein the auto gain correction factor is determined by dividing an actual displacement of a brake stack under 100% braking force by an expected displacement of the brake stack at 100% braking force for a given wear state of the brake stack.

10. The aircraft of claim 9, wherein the expected displacement of the brake stack at the 100% braking force is determined during brake system development and qualification and is stored as data in the electromechanical brake actuator controller.

11. The aircraft of claim 9, wherein the actual displacement is an indication of a specific force applied to the brake stack that is at a particular wear state and wherein the expected displacement of the brake stack is based on the same particular wear state of the brake stack.

12. The aircraft of claim 8, wherein the brake system further comprises:
a load cell,
wherein determining the correct level of braking force comprises the electromechanical brake actuator controller being configured to:
responsive to receiving the commanded level of braking force from the brake control unit, identify an electromechanical brake actuator power required to achieve the commanded level of braking force;
send the electromechanical brake actuator power to the electromechanical brake actuator;
receive, from the load cell, an applied braking force signal indicating the measured level of braking force corresponding to the electromechanical brake actuator power;
correct the measured level of braking force by the auto gain correction factor thereby forming a corrected braking force;
determine whether the corrected braking force has achieved the commanded level of braking force; and
responsive to the corrected braking force failing to achieve the commanded level of braking force, send an adjusted electromechanical brake actuator power to the electromechanical brake actuator.

13. The aircraft of claim 12, wherein determining the correct level of braking force comprises the electromechanical brake actuator controller being configured to:
responsive to the corrected braking force achieving the commanded level of braking force, maintain the electromechanical brake actuator power to the electromechanical brake actuator.

14. The aircraft of claim 8, wherein the electromechanical brake actuator is a plurality of electromechanical brake actuators, wherein the electromechanical brake actuator controller is configured to command each electromechanical brake actuator of the plurality of electromechanical brake actuators individually to apply a respective correct level of braking force, the respective correct level of braking force being a respective measured level of braking force corrected by a respective auto gain correction factor associated with the respective electromechanical brake actuator.

15. A method of controlling an electromechanical brake actuator of a brake system comprising:
receiving, by an electromechanical brake actuator controller, a commanded level of braking force from a brake control unit, wherein the commanded level of braking force is to extend a ball screw within the electromechanical brake actuator toward a pressure plate and exert a force on the pressure plate, rotating discs, stationary discs, and an end plate to generate a braking torque; and
commanding, by the electromechanical brake actuator controller, the electromechanical brake actuator to apply a correct level of braking force, the correct level of braking force being a measured level of braking force corrected by an auto gain correction factor.

16. The method of claim 15, wherein the auto gain correction factor is determined by dividing an actual displacement of a brake stack under 100% braking force by an expected displacement of the brake stack at 100% braking force for a given wear state of the brake stack.

17. The method of claim 16, wherein the expected displacement of the brake stack at the 100% braking force is determined during brake system development and qualification and is stored as data in the electromechanical brake actuator controller.

18. The method of claim 16, wherein the actual displacement is an indication of a specific force applied to the brake stack that is at a particular wear state and wherein the expected displacement of the brake stack is based on the same particular wear state of the brake stack.

19. The method of claim 15, further comprising:
determining, by the electromechanical brake actuator controller, the correct level of braking force by:
responsive to receiving the commanded level of braking force from the brake control unit, identify, by the electromechanical brake actuator controller, an electromechanical brake actuator power required to achieve the commanded level of braking force;
sending, by the electromechanical brake actuator controller, the electromechanical brake actuator power to the electromechanical brake actuator;
receiving, by the electromechanical brake actuator controller from a load cell, an applied braking force signal indicating the measured level of braking force corresponding to the electromechanical brake actuator power;
correcting, by the electromechanical brake actuator controller, the measured level of braking force by the auto gain correction factor thereby forming a corrected braking force;
determining, by the electromechanical brake actuator controller, whether the corrected braking force has achieved the commanded level of braking force; and
responsive to the corrected braking force failing to achieve the commanded level of braking force, sending, by the electromechanical brake actuator controller, an adjusted electromechanical brake actuator power to the electromechanical brake actuator.

20. The method of claim 19, further comprising:
responsive to the corrected braking force achieving the commanded level of braking force, maintaining, by the electromechanical brake actuator controller, the electromechanical brake actuator power to the electromechanical brake actuator.
